(19) United States
(12) Patent Application Publication
(10) Pub. No.: US 2013/0204738 A1
(43) Pub. Date: Aug. 8, 2013

(54) SYSTEMS AND METHODS FOR RECOMMENDING ENTITIES TO ONLINE CUSTOMERS

(71) Applicant: Agilone Inc., Mountain View, CA (US)

(72) Inventors: Omer Artun, Los Gatos, CA (US); Dhruv Bhargava, New Haven, CT (US); Anselme Le Van, San Jose, CA (US)

(73) Assignee: Agilone Inc., Mountain View, CA (US)

(21) Appl. No.: 13/830,516

(22) Filed: Mar. 14, 2013

Related U.S. Application Data
(63) Continuation-in-part of application No. 13/359,384, filed on Jan. 26, 2012.
(60) Provisional application No. 61/436,447, filed on Jan. 26, 2011.
(60) Provisional application No. 61/436,460, filed on Jan. 26, 2011.
(60) Provisional application No. 61/436,465, filed on Jan. 26, 2011.
(60) Provisional application No. 61/436,467, filed on Jan. 26, 2011.
(60) Provisional application No. 61/436,473, filed on Jan. 26, 2011.
(60) Provisional application No. 61/436,479, filed on Jan. 26, 2011.

(51) Int. Cl. G06Q 30/06

(52) U.S. Cl. CPC G06Q 30/0631
USPC 705/26.7

(57) ABSTRACT

System and methods for recommending entities (e.g., products, documents, movies, persons, etc.) to online customers are provided. A centroid definition module generates a plurality of centroids that at least partially describe one or more users based on documents consumed by the respective users of the one or more users and node data assigned to the respective documents within a node space. A centroid assignment module projects user data describing each of the one or more users in the node space, calculates user-centroid membership values, and assigns the respective users to a certain centroid based on a highest membership value of the respective users.

### CROSS-REFERENCE TO RELATED PATENT DOCUMENTS

This patent application is a continuation-in-part of U.S. patent application Ser. No. 13/359,384 filed Jan. 26, 2012 which claims the benefit of priority, under 35 U.S.C. Section 119(e), to U.S. Provisional Patent Application Ser. No. 61/436,447, entitled “System for Blending Propensity and Product Affinity in Recommendation Engine,” filed on Jan. 26, 2011, and to U.S. Provisional Patent Application Ser. No. 61/436,460, entitled “Intelligent Personalized Recommendation Engine and Search Enhancement,” filed on Jan. 26, 2011, and to U.S. Provisional Patent Application Ser. No. 61/436,465, entitled “System for Making Product/Service Recommendations with Query Sessioning and Sequencing,” filed on Jan. 26, 2011, and to U.S. Provisional Patent Application Ser. No. 61/436,467, entitled “System for Customer Segmentation Based on Product Affinity and Buying Propensity,” filed on Jan. 26, 2011, and to U.S. Provisional Patent Application Ser. No. 61/436,473, entitled “System for Customer Segmentation Based on Entities to be Served,” filed on Jan. 26, 2011, and to U.S. Provisional Patent Application Ser. No. 61/436,479, entitled “System for Generating Reverse Recommendations,” filed on Jan. 26, 2011, the benefit of priority of each of which is claimed hereby, and each of which are incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011-2012 Agilone Inc. All Rights Reserved.

### TECHNICAL FIELD

This patent document pertains generally to data processing and network communication, and more particularly, but not by way of limitation, to recommending entities to online customers.

### BACKGROUND

Some online customers/users know in advance precisely what they want. When they shop on line, they are said to be ‘searching’ for the specific items they desire. Other online customers/users are content to ‘browse’ online before deciding what to buy/download/connect. Both types of customers/users tend to be open to helpful suggestions.

In addition, marketers and managers frequently have specific entities they would like to bring to customers' attention. In order to achieve that, most managers use rule-based selection criteria to find customers to contact.

Many successful online businesses such as Amazon and Netflix have learned the value of devising and supplying good recommendations to online customers during the critical period during which they are making their minds up about what products or services to buy. Such companies tend to keep track of a given customer's browsing history, that customer's past purchases, and the purchases of other customers, and to use that information to devise smart recommendations, thereby increasing the likelihood of a sale. In addition, there are other instances where companies could recommend entities to users, or users to entities. In such instances, very few solutions exist that provide an effective personalized solution.

### BRIEF DESCRIPTION OF DRAWINGS

Some embodiments are illustrated by way of example and not limitation in the figures of the accompanying drawings in which:

FIG. 1 is a diagrammatic representation of an example networked environment in which various embodiments may be practiced, according to example embodiment.

FIG. 2 is a block diagram of a specialized recommendation engine, according to an example embodiment.

FIG. 3 is a flowchart of a method used to modify content, according to an example embodiment.

FIG. 4 is a block diagram of a search engine, according to an example embodiment.

FIG. 5 is a flow chart illustrating a method to provide modified content, according to an example embodiment.

FIG. 6 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

A recommender system predicts which entities (e.g., products, documents, movies, persons, etc.) are likely to be of interest to a user. If a user browses entities on a website, the recommender system is able to build recommendations for the user in real-time based on the entities the user is browsing. Recommendations are refined as the user reveals more and more about himself or herself by viewing or interacting with some entities and not others.

The algorithm can be divided in two stages. First, pre-calculated scoring tables are created and maintained offline. Those tables are updated on a daily basis. Second, personalized recommendations are calculated on demand and on the fly at run-time. This step uses the pre-calculated scoring tables created during first stage.

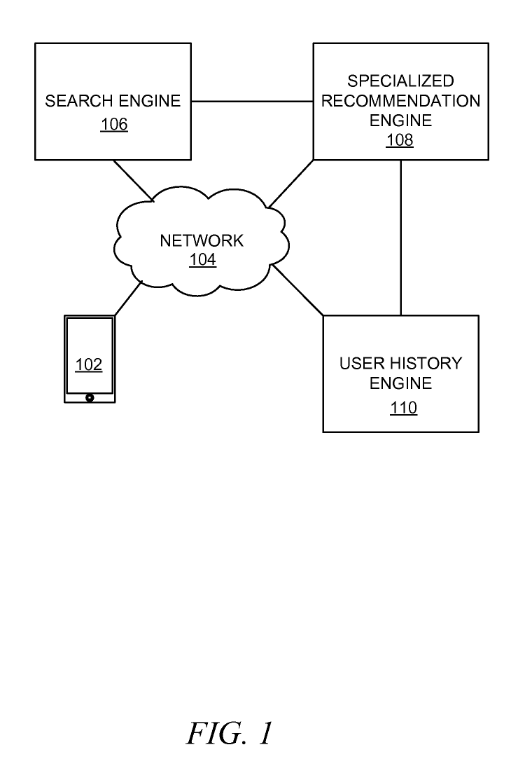

FIG. 1 is a diagrammatic representation of an example networked environment in which various embodiments may be practiced, according to example embodiment.

A user device 102 (e.g., a handheld mobile device, a tablet computer, a laptop computer, or a desktop computer) may be used by a user to access a network 104 using software applications (e.g., a web browser or a mobile application). The user may access a search engine 106 to identify or discover websites that are relevant to the user on the World Wide Web (WWW) or the Internet.

A specialized recommendation engine 108 is configured to define, create, and maintain centroids that describe characteristics assigned to a group of users. To generate centroids, groups of users are defined based, for example, on attributes (such as job role, company industry, homepage, and alerts) and document consumption. Due to this data being relatively sparse, the centroids, are defined around clusters of users having similar document consumption data. Based on the centroid(s) a user is ultimately assigned to, the specialized recommendation engine 108 is configured to modify content according to one or more functions.

A user history engine 110 is configured to access user browsing data, user behaviours performed by each user into one or more sessions, and purchase history of each of the one or more users. User browsing data may include search queries submitted to a search engine 106, identifications of documents viewed by the user, and the like. Behaviours performed by the user may include portions of the document viewed for threshold periods of time, links within a document selected by a user, or the like.

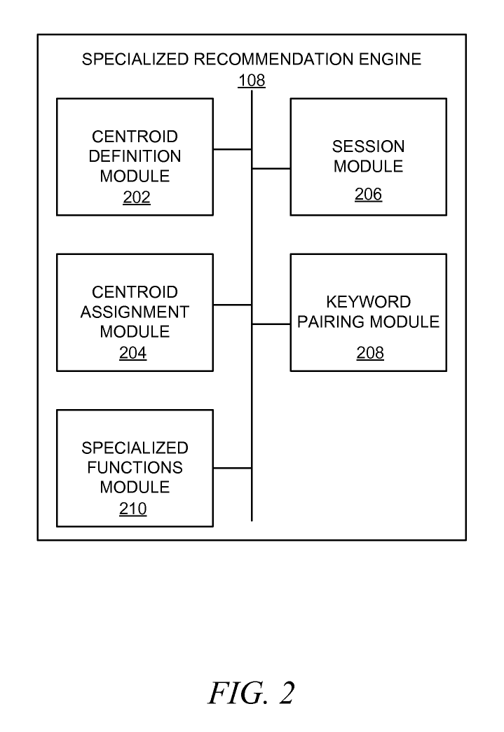

FIG. 2 is a block diagram of a specialized recommendation engine 108, according to an example embodiment. The specialized recommendation engine 108 may be implemented in hardware, software, or a combination thereof.

A centroid definition module 202 is configured to generate or create a plurality of centroids that at least partially describe one or more users. The centroid definition module extracts input data, transforms the data, and determines centroids based thereon.

The input data includes a document consumption table and a document-node table. The document consumption table maps a user identifier (uniquely assigned to each user) to unique document identifiers assigned to each of the documents viewed by the user. The document consumption table may include additional information such as an email address of the user, a time at which the user viewed a particular document, and information about the document (e.g., a title of the document). In some instances, data from a limited period of time (e.g., six months) may be used. The users may be selected based on known group membership (e.g., based on an attribute such as job role).

A second input is a document-node table. The document-node table maps known documents to a pre-defined node based, for example, on a topic of the document.

Based on the two input tables, a user-to-node consumption matrix is generated. The user-to-node consumption matrix includes a mapping of a user identifier to a node identifier and a number of documents (read by each user) that are assigned to the node identifier. At this stage, outlying nodes have too few or too many distinct users may be removed. For example, nodes with less than twenty users or more than four thousand users may be removed.

The user-to-node consumption matrix is then transformed to generate a normalized low-dimensional user-to-node consumption matrix. First, the user-to-node consumption matrix is transformed into a sparse matrix indicating the number of distinct documents downloaded by a user for a given node. The resulting matrix is then normalized using a projection onto a unit cube. Lastly, the dimensionality of the user*node document space is reduced by selecting only the most important eigenvectors.

The normalized low-dimensional user-to-node consumption matrix is used to determine user centroid coordinates in the node space. First, fuzzy clustering is performed using a fuzzy k means algorithm (with cosine distance) run in the projected user*node document space. Then optimal centroids are selected by calculating an objective function and observing convergences. The operation is repeated to confirm convergence. Then the centroids coordinates in the actual node space are calculated. Each centroid is then given an arbitrary name based on the most important nodes defining each centroid. Finally, the centroids are exported to an SQL (structured query language) environment.

This way, clusters of users are identified within the “regionalized” universe of the node space. These clusters help maximize the similarity of customer behavior within a same cluster and minimize the similarity of user behavior across clusters. Direct and indirect similarity measures may be used. Direct measures include connected graphs where people have connections with each other and indirect connections are people with similar download, purchase, and/or browsing history.

A centroid assignment module 204 is configured to determine members of the respective centroids as defined by the centroid definition module 202. The centroid assignment module 204 projects the user data in the node space, calculates user-centroid membership values, and optionally assigns users to the centroid for which they have the highest membership value.

The centroid assignment module 204 is configured to receive the user-to-node consumption matrix and the user centroid coordinates in node space and to output a user-centroid membership matrix. This clustering is fuzzy meaning that each user can belong to several clusters. The membership of the user to a cluster is expressed as a score ranging from 0 to 1. The sum of the membership values for each user is 1.

Once a satisfactory fuzzy clustering is obtained, the algorithm builds recommendations personalized at the cluster level. For a particular cluster, the behavior of users is weighted with their membership value for the considered cluster. For example, if a user belongs 100% to a cluster C, their behavior may be taken into account with a 100% weight when building the recommendations for cluster C. Conversely, if a user belongs only 5% to cluster C, their behavior may be weighted accordingly when building the recommendation scores for cluster C.

A session module 206 is configured to group queries submitted by a user into one or more sessions. A session is defined as one or several queries executed by a same user who searches a document about a certain topic during a certain period of time. It may be helpful to not only look at the query that leads to the download of a document but to also use the information given by all the queries that precede the download.

To be grouped into a session, a plurality of queries are grouped based on one or more rules. These rules may include, for example: queries submitted from a same IP address and by same user identifier (if user is identified). If a query has no user identified, then a submitted query will be grouped with the nearest query in time for which a user is identified if it exists. Another rule may be that two consecutive queries must be in a five minute time window. A further rule may be that two consecutive queries must share at least one uncommon word.

The input to the session module 206 comprises historical search data that indicates a timestamp of the search query, an IP address from which the query was submitted, at least a portion of the terms included in the query, an event performed by the user based on the results of the query, a number of clicks received in response to the results of the query, a user identifier of the user who submitted the query, and the like.

The grouping is performed. All current contents of a SearchGroup table are cleared (table truncated). Next, all of the items (queries) to process are retrieved and ordered by IP and timestamp. Then, once the IP address of the user switches value, that group is processed (all items from that IP address).

Next the items are grouped by user. All entries whose UserID is null is updated to have the UserID of the query nearest to it which a user is identified. If all the entries for a given IP have no user associated then they would all belong to one group. Otherwise, entries will be grouped by user.

Then the items are grouped by timestamp and keyword. Each entry in every user group is compared to all entries after it that is within the time allowance (e.g., 5 minutes) and if their keyphrases share at least one uncommon word then they will be assigned the same UniqueID. It is possible that the entry being compared already has UniqueID assigned to it and is less than the ID of the current entry. In this case the lower ID will be taken. For example: Q1=hello world; Q2=world; Q3=magic quadrant; and Q4=magic world. During the processing of Q1, Q4 will be identified as related thus: Q1-UniqueID1; Q2-UniqueID1; Q3-NULL; Q4-UniqueID1. When Q3 is processed, it will match Q4 (on term “magic”) and will take the UniqueID of Q1. If no matches are found within timestamp and related keyword, that entry will have a UniqueID equal to its ClickID (effectively becomes a group of its own).

Next, DocumentID processing for each IP and User group is performed. A list of documentID and its associated entries are created but no regrouping is made here. Each entry is processed (if the documentID is empty, the processing is skipped). If the document ID is not empty then evaluate the previous entries and associate the documentID with each one of them. For example: Q1-docNULL; Q2-doc1; Q3-doc2. This processing will result in: Q1-doc1; Q1-doc2; Q2-doc1; Q2-doc2; and Q3-doc2. Given the example, in case Q1 and Q2 have the same keyphrase then without special handling it will result in: Q1-doc1; Q1-doc2; Q1-doc1; Q1-doc2; Q3-doc2. However this situation is handled so that there is no redundancy in Q1-doc1 and Q1-doc2. The timestamp of resulting Q1-doc1 and Q1-doc2 will be the latest one.

Next, the groupings are saved to a database (not shown). Before saving, the lowest ID in all entries for a given IP-User is determined and used as the UniqueID for that group. This is because some entries might get eliminated by the documentID processing above. And if that entry happens to be used as the basis for the UniqueID for that group then the resulting UniqueID will be something that has no corresponding ClickID in the entries saved to the DB (SearchGroup table). For example: ID1-Q1-doc1; ID2-Q1-doc1; ID3-Q2-doc2. After document consideration it will result in (assuming all three are related): ID2-Q1-doc1-UniqueID1; ID3-Q2-doc2-UniqueID1. Q1-doc1 is constrained to be unique and ID2 is the latest entry, ID 1 will be eliminated. But UniqueID is still set to 1. In this case, just for clarity, UniqueID is updated to become UniqueID2 since ID2 is the lowest ID in the group. For each entry/click, the keyphrase is split (based on space). If more than one part results, the whole keyphrase is saved first, then eventually the individual keywords/parts. If the part is a noiseWord then it is not saved.

The rank is then updated. The rank is reset for every SearchID, DocumentID and ordered based on the order of the entry from the source (ClickID which is actually based on timestamp).

As such, the session module 206 allows search results to be made more relevant if based on the statistical relationships between queries and click behavior. The session module evaluates queries from a search session perspective. A search session is defined as a succession of queries aimed at the discovery of a specific entity. For example, a user may type a first query, be unsatisfied with the proposed results, type a second query and be unsatisfied with the results again, type a third query—which yields the answer they are looking for and they click on a product. The session module 206 tracks the entire search trail and groups those three queries into a search session. The sessioning of queries refers to the process through which queries are grouped together based on their similarity of purpose. The sessioning of queries follows a set of rules which can be adapted from a context to another. Generally speaking, queries in a same session must be executed by a same user in a determined timeframe and two succeeding queries should have at least one word in common. When building keyword-to-product correlation statistics, the session module 206 not only associates the last query to a clicked entity. But it also associates the previous queries to the ultimately clicked entity. Less weight is given to the previous unsuccessful query and even less weight is given to the query before that because the distance between the query and the click action is greater. This allows a faster, more relevant searching experience because we gave a higher weight to the most successful search term—product being searched for.

Because queries are grouped into sessions based on having at least one word in common, it may be helpful to account for declinations and variations in keywords. Common instances may include singular versus plural forms of nous, capitalizations, misspellings, and the like. To improve search results, the session module 206 replaces declinations of those words with one common declination. To do so, the algorithm looks at past searches to determine whether a singular or plural, capitalized or not capitalized, or other variation is more commonly used as part of a query.

More specifically, four types of corrections may be made. First, words ending in “-ies” may be modified. For example, “lies” may be modified to “lie” and “commodities” may be modified to “commodity”. Second, words ending in “-oes” may be modified. For example, “does” may be modified to “do” and “woes” may be modified to “woe”. Third, other words ending in “-s” may be modified. For example, “computers” may be modified to “computer”. Fourth, words ending in “-ed” may by modified. For example, “approved” may become “approve”; “attached” may become “attached”; and “certified” may become “certify”.

A keyword pairing module 208 is configured to identify pairs (or larger sequences) of keywords that have a meaning when taken together. Keyword-to-document statistics are built upon the identified pairs of keywords rather than each keyword taken alone. For example, the keywords, “data” and “storage” may be identified as a pair so that the query becomes “data.storage”

To identify keyword pairs, a table with all keyword duplets found in cleansed historical search data is created. Then a number of times a keyword K1 was used versus how many times this keyword appeared with another keyword, K2, is counted. The “Number of times K1-K2 appear together” together is then divided by “number of times K1 appears alone” is an approximation of the conditional probability of K2 in the query knowing that K1 is in it. Keywords K1 and K2 are paired together if number of sessions with K1 and K2 is more than 200 of if max(prob(K1|K2),prob(K2|K1) is more than 60%. Single keywords in cleansed historical search data are replaced by selected duplets.

A specialized functions module 210 is configured to apply one or more specialized function to retrieved documents to compute keyword-to-document statistics. For example, the specialized functions module 210 may build keyword-to-document statistics and/or apply memory-time-decaying function used to modify keyword-to-document statistics.

To build keyword-to-document statistics, a keyword-to-document master score table is created. Every document is assigned a set of keywords. Each keyword has a weight that varies depending on user centroid. This weight is a metric that measures the distance between a keyword and a document for a user in a particular cluster. For each query, a score computed according a well-chosen metric formula that defines how close a keyword is to the searched document. A master score table is created from the aggregation of previous records. Each row gives a score for a particular word-to-document relationship. This value is the sum of scores for records from previous step with the same word-to-document relationship. A master conditional probability table is created. Each record stores a conditional probability of having a document downloaded knowing one specific keyword. This value is defined as the score of the considered word-to-document relationship divided by the sum of scores for same-word-to-all-documents. The keyword-to-document master score table is generated based on a cleansed keyword-paired keyword-to-document table and a user-centroid membership matrix.

First, a distance of a keyword to documents based on rank is calculated using a scoring function such as one of the below:

$$f 1 ( word ) = {\sum }_{i = 1}^{n} X ( word , i ) \text{?}$$

$$f 2 ( word ) = \text{?}$$

$$f 2 ( word ) = \text{?}$$

$$\text{?} \text{indicates text missing or illegible when filed}$$

Second, a time-decay function may be used to calculate the aging of documents based on a date of latest download. The function may be approximated by a rational function with a linear polynomial numerator and denominator. The time-decay function may be used as a multiplication factor to decrease the weight of older queries. For instance, the current time-decay function gives a value of 1 for queries that are zero-day old and a value of 0.1 for queries that are 200 days old. That means that the information given by a zero-day old query is given ten times more weight than a query executed 200 days ago.

Third, the master score table is built over the sessions. Keyword-to-document relationships and weights are recorded for all sessions. This results in a large table with seach_id, keyword, document_id, and score. Those records are grouped by keyword and documentid. The columns of this aggregated table are ‘keyword’, ‘document’, and ‘sum(scores)’.

Fourth, a word-to-document conditional probability table is built. The word-to-document conditional probability table gives the conditional probability of having a certain document downloaded knowing that a certain keyword is in the query. This conditional probability is referred to as a “gross probability”:

$$Gross probability ( \text{?} ) = \{ \begin{matrix}if \text{?} ( score ( score ( \text{?} ) = 0 , & \frac{score ( \text{?} )}{\text{?} score ( \text{?} )} \\ otherwise , & 0\end{matrix} \}$$

$$\text{?} \text{indicates text missing or illegible when filed}$$

Returning to the second step, calculating the time-decay function. The time-decay function is used to ensure that a query executed 6 months ago is given less importance than a query executed today. One underlying assumption is that a same query will lead to different documents as time goes by. Indeed, some back and forth testing shows that results improve when the algorithm ‘slowly forgets’ about the past. If someone downloaded a document ‘i’ with a keyword ‘k’ six months ago, there is little chance that a user will download this same document ‘i’ today after he or she has used keyword ‘k’.

The function is used to calculate how fast the algorithm forgets past data. The steeper the time-decay function, the faster the algorithm forgets past results. The higher amount of noise we have from obsolete query-to-document relationships is balanced with having the less information to use from search history. A sensibility analysis showed that the optimal time-decay function is approximately the function that describes how a document becomes obsolete based on its date of latest download.

To illustrate, consider a document ‘i’ in a corpus. To determine if this document is obsolete, various approaches may be used. One approach is to look at the publication date of the document. The older the document, the lower the probability of this document to be downloaded again. This approach gave a first set of results because 62% of documents have a life time greater than one year (number of days between first download and last download). Also, the recency-curve shows that for 30% of downloads, the document downloaded is more than one year old. For 10% of downloads the document is more than 2 years old. This ratio is high and does not help to discriminate between relevant and obsolete documents. A second predictor was the number of days since the document was last downloaded. A document is unlikely to be downloaded if the last time this document was downloaded is a long time ago. A document may have a very old publication date (e.g., two years ago). But if this document was downloaded yesterday, one can assume that it is still an active, relevant document. Conversely, a document may have a publication date only six months old. If this document was downloaded for the last time four months ago, one can assume that this document is unlikely less likely to be downloaded today. It is found that for 90% of downloads, the document downloaded had already been downloaded previously less than 10 days ago. For 70% of documents, the maximum number of days between 2 downloads is less than 200 days.

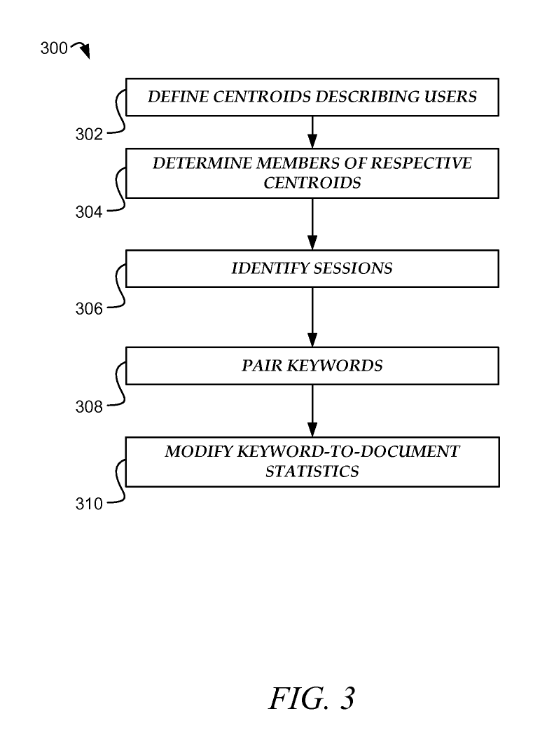

FIG. 3 is a flowchart of a method 300 used to modify content, according to an example embodiment. The method 300 may be performed by the recommendation engine 106. In an operation 302, centroids describing users are defined by, for example, the centroid definition module 202. In an operation 304, the members of the respective centroids are determined by, for example, the centroid assignment module 204. In an operation 306, sessions are identified by, for example, the session module 206. In an operation 308, keywords are paired by, for example, the keyword pairing module 208. In an operation 310, the keyword-to-document statistics may be modified using the specialized functions module 210.

Thus, the calculations performed by the specialized recommendation engine 106 may be performed offline and result in three outcomes: first, the transformation process through which customer behavior is translated in the “regionalized universe” (aka normalization and dimensionality-reduction) is created; second, the coordinates of the centroids for each identified cluster are calculated; and third, the recommendation scores for each cluster are calculated. Clustering projects the users onto a lower dimensional space where the statistics are more robust and enables faster real-time personalized calculations at run-time.

Recommendation calculations may be performed at runtime by the search engine 108. The following describes actions performed by the search engine 108 when personalized recommendations are requested for a user. First, recorded user behavior is translated back into the “regionalized” universe according to the transformation process used in offline stage. Second, the distances of the user to the centroids are calculated. Centroid membership values are calculated based on those distances. Last, the recommendations applying to each cluster are put together and weighted using the membership values of the user and combined appropriately in order to make a final 100% personalized recommendation.

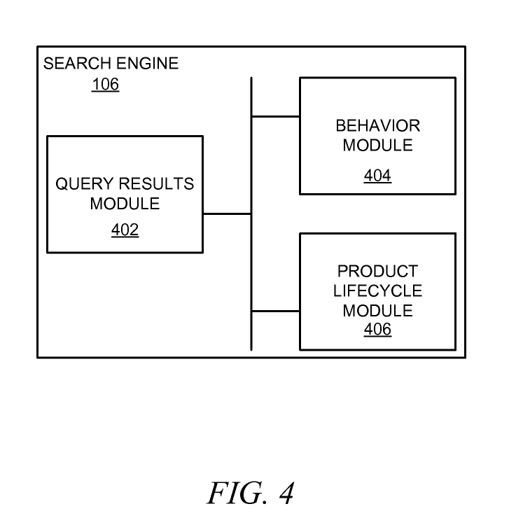

FIG. 4 is a block diagram of the search engine 108, according to an example embodiment.

A query results module 402 is configured to provide various recommendations to a user based on the centroids assigned to the user. More specifically, the users are segmented into segments based on behavior and attributes that are described in terms of the clusters and centroids of FIG. 2. For example, to create recommendations for a company that sells shoes, the customers are segmented into clusters of users having similar product interests (for instance, sports shoes buyers, all-weather shoes buyers, dress shoes buyers etc.) and similar behavior (for example, occasional buyers, seasonal buyers, frequent buyers, closeout buyers etc.).

The centroid and cluster algorithms allow for flexibility in that the variables that are pertinent to customers in one cluster may not be relevant in creating recommendations for customers in other clusters. Customers with inadequate behavioral or purchase patterns may be assigned to the closest cluster they belong to, and re-clustered at each possible instance of new available data

In some instances, users may be segmented based on entities to be served given a product or set of products. For example, a set of products or product sets are used as inputs (e.g., 4 groups of 5 products each). Given this set, the affinity of each product in the set to each customer and the customer's overall likelihood to purchase can be calculated. These two scores first segments the customers into groups corresponding to each product set—depending on which product set they have most affinity towards. Then, they help create a decision boundary that helps decide whether the customer should be marketed to or not, since a customer may have high affinity towards products but may not be likely to buy it at the time. The outcome is that the marketer has the ability to send a customized message about the product sets to the correct audience.

A behavior module 404 uses past user behavior to modify recommendations. For example, if there are two people who have bought a laptop, one of them a month ago (customer A), and the other a week ago (Customer B). Then Customer B browsed the website for some more products to go with their laptop. Based on this product purchase and browsing behavior, both customers would be offered (for example) a laptop battery. However, Customer B is the more recent customer who also browsed the web for additional products to go with their laptop. If one calculates the response probability for these two customers, Customer B will (most likely) have the higher likelihood of returning and making a purchase. Since Customer A has a lower probability to purchase anything than Customer B, we can make a more aggressive offer to Customer A. Customer A was not likely to return anyway—so sending them an aggressive offer can only bring in incremental margin/revenue. On the other hand, since Customer B is very likely to return, there is no need to send them the same aggressive offer. Instead they can be sent the usual offer and earn revenue/margin without losing any money due to having to give them any discounts.

The behavior module 404 may further be used to exploit the phenomenon that the more products a customer buys from a company, or the more categories he or she makes their purchases from, their value of the relationship between the company and customer is higher. The behavior module 404 is configured to choose products that the customer may not have the affinity to buy/download/engage (depending on their past transaction history and the products they may have shown interest in). For example, the marketer may provide an incentive discount for introducing the product to the customer where the customer is not likely to buy this product under normal conditions or given their past history. The customer then is introduced to a new product which they may not have been aware of, at a discounted rate.

A product lifecycle module 406 is configured to apply product lifecycle information to the recommendations made to the user. Product lifecycle information includes information describing events in the product lifecycle such as product introduction, seasonality, and frequency of replacement.

When new products (or entities) are introduced by the company, these products have no prior purchase/browsing history. So the usual statistical recommendations do not apply. To create relevant recommendations for these products, category roll-up and attribute similarity measures are used. Category roll-up involves recommending products from the category that the product or entity belongs to. Attribute similarity measure involves recommending products or entities that have similar attributes.

Products/Entities have natural seasonal cycles in which they get purchased, e.g., Christmas-patterned tablecloths do not sell in January, heaters do not sell in the summer, and Halloween costumes only sell in the fall through October. A seasonality index is created for the products' natural seasonality that boosts or suppresses the recommendation index of the product, depending in which season the recommendations are being made.

Different products/entities have a natural lifecycle before they need to be replaced or purchased again by the same person. For instance, laptops and desktops may last at least a couple of years, but printer cartridges may be needed every few months. A replacement index takes this natural lifecycle of re-purchase into account. This index indicates when it is pertinent to recommend a product the customer has bought previously again, and for what period recommending a previously purchased product would be irrelevant to that customer.

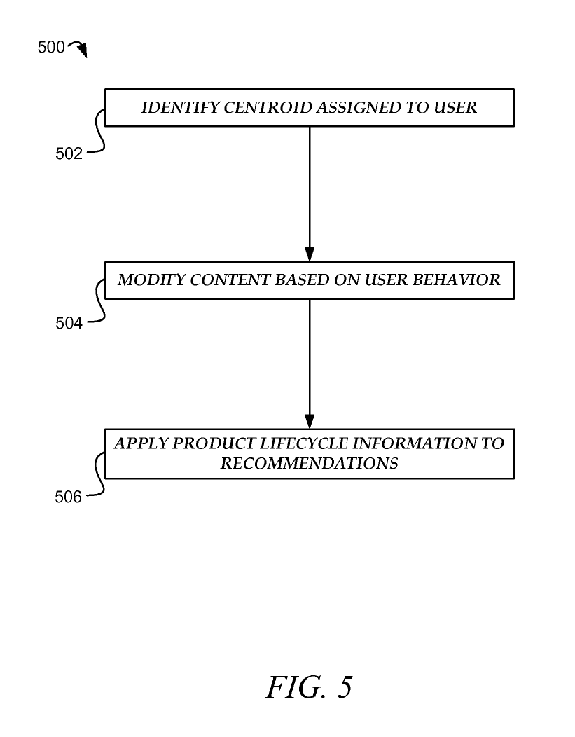

FIG. 5 is a flow chart illustrating a method 500 to provide modified content, according to an example embodiment. In an operation 502, a centroid assigned to the user is identified by the query results module 402. In an operation 504, content is modified based on user behaviour by the behaviour module 404. In an operation 506, product lifecycle information is applied to recommendations by the product lifecycle module 406.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

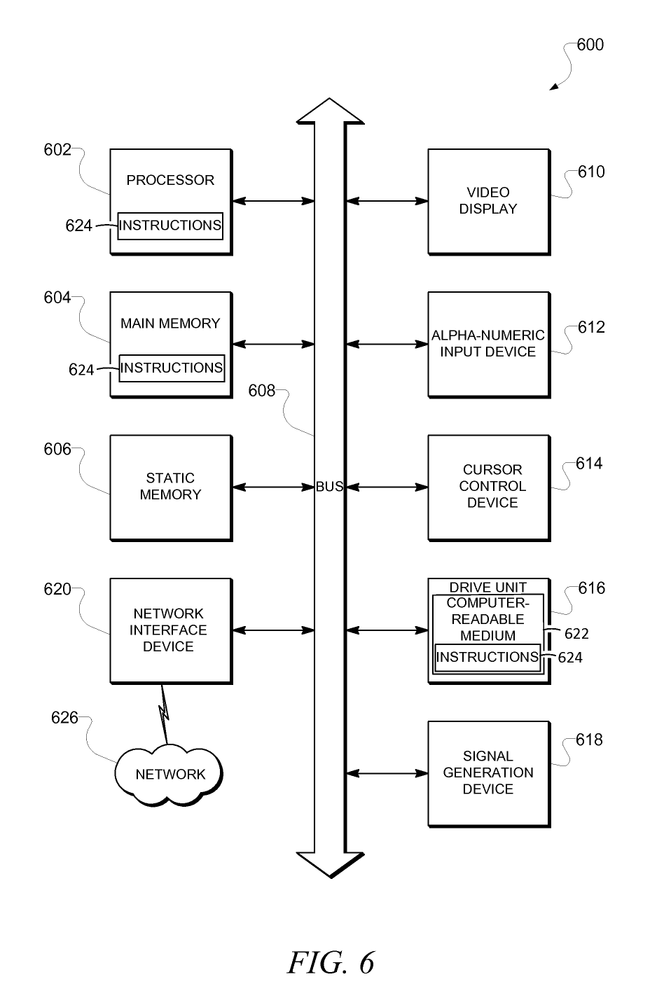

FIG. 6 is a block diagram of machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a centroid definition module configured to generate a plurality of centroids that at least partially describe one or more users based on documents consumed by the respective users of the one or more users and node data assigned to the respective documents within a node space; and
a centroid assignment module configured to, using one or more processors, project user data describing each of the one or more users in the node space, calculate user-centroid membership values, and assign the respective users to a certain centroid based on a highest membership value of the respective users.

2. The system of claim 1, wherein the centroid definition module is further configured to give each centroid of the plurality of centroids an arbitrary name.

3. The system of claim 1, wherein the centroid assignment module is configured to assign the one or more users to a cluster based on the highest membership value of the respective users to at least two centroids.

4. The system of claim 1, wherein the centroid assignment module is configured to cluster the respective users of the one or more users to at least two clusters.

5. The system of claim 1, further comprising:
a session module configured to group queries submitted by the respective users of the one or more users into one or more sessions, a session of the one or more sessions including a plurality of queries executed by the respective users about a certain topic during a certain period of time.

6. The system of claim 5, wherein the session is based on the plurality of queries sharing at least one keyword.

7. The system of claim 5, wherein the session module is further configured to replace declinations of submitted keywords with one common declination.

8. The system of claim 1, further comprising a keyword pairing module configured to identify pairs of keywords that have meaning when taken together.

9. The system of claim 1, further comprising:
a specialized function module configured to generate keyword-to-document statistics.

10. The system of claim 9, wherein each document of the documents is assigned a set of keywords, each keyword assigned a weight that varies according to centroid.

11. The system of claim 10, wherein the specialized function module is further configured to apply a time-decay function to the weight.

12. The system of claim 11, wherein the time-decay function is based on a date of latest download of the document.

13. The system of claim 1, further comprising a query results module configured to provide recommendations to the respective users of the one or more users based on the centroids assigned to the respective users.

14. The system of claim 1, further comprising a behaviour module configured to modify a recommendation based on a past purchase made by the respective users of the one or more users.

15. The system of claim 1, further comprising a behaviour module configured to generate a recommendation to introduce the respective users to a new product.

16. The system of claim 1, further comprising a product lifecycle module configured to provide a recommendation based on a category or attribute of a new product.

17. The system of claim 1, further comprising a product lifecycle module configured to provide a recommendation based on a seasonal cycle.

18. The system of claim 1, further comprising a product lifecycle module configured to provide a recommendation based on replacement index of a product.

19. A method comprising:
generating a plurality of centroids that at least partially describe one or more users based on documents consumed by the respective users of the one or more users and node data assigned to the respective documents within a node space;
using one or more processors, projecting user data describing each of the one or more users in the node space;
calculating user-centroid membership values; and
assigning the respective users to a certain centroid based on a highest membership value of the respective users.

20. A non-transitory computer-readable medium having instruction embodied thereon, the instructions executable by one or more processors for performing operations comprising:
generating a plurality of centroids that at least partially describe one or more users based on documents consumed by the respective users of the one or more users and node data assigned to the respective documents within a node space;
using one or more processors, projecting user data describing each of the one or more users in the node space;
calculating user-centroid membership values; and
assigning the respective users to a certain centroid based on a highest membership value of the respective users.
